(19) United States
(12) Patent Application Publication
(10) Pub. No.: US 2008/0018520 A1
(43) Pub. Date: Jan. 24, 2008

(54) Aircraft Anti-Missile Protection System

(75) Inventor: Dominique Moreau, Issy-Les-Moulineaux (FR)

Correspondence Address: LOWE HAUPTMAN & BERNER, LLP, 1700 DIAGONAL ROAD, SUITE 300, ALEXANDRIA, VA, 22314, US

(73) Assignee: THALES, NEUILLY-SUR-SEINE (FR)

(21) Appl. No.: 11/568,948

(22) PCT Filed: May 10, 2005
(86) PCT No.: PCT/EP05/52111

§ 371 Date: Nov. 10, 2006

(30) Foreign Application Priority Data
May 11, 2004 (FR) 04/05087

(51) Int. Cl. G01S 7/38; G01S 13/00

(52) U.S. Cl. 342/14; 342/53; 342/54

(57) ABSTRACT

The present invention relates to an anti-missile protection system for an aircraft (30), and applies in particular to the protection of civilian and military airplanes, and to that of helicopters, against the firing of ground-to-air missiles equipped with homing heads.

According to the invention, the system comprises at least one optoelectronic module (10, 10_{A}, 10_{B}), each module being equipped with a device for detecting and tracking missiles in a given space, with, in particular, a missile jamming laser beam emitting head (23, 44), and, for each optoelectronic module, a service box (11, 11_{A}, 11_{B}) for controlling and supplying power to the module, each box being remote from the optoelectronic module that it controls and also comprising the electronics for controlling the jamming laser of said module.

For example, the protection system comprises two optoelectronic modules mounted nose-to-tail at the top of the stabilizer (301) of the airplane and one optoelectronic module under the nose (302) of the airplane.

The present invention relates to an anti-missile protection system for an aircraft, and applies in particular to the protection of civilian and military airplanes, and that of helicopters, from the firing of ground-to-air missiles equipped with homing heads.

In recent years, it has become apparent that civilian airplanes could also be the subject of attack, for example by terrorist groups equipped with existing portable ground-to-air missiles in large numbers following the recent conflicts around the world. It is therefore becoming necessary to protect these airplanes against these threats. Civilian airplanes, taking off from airports that can be located in towns, require sophisticated self-protection means which need to satisfy certain criteria, including, in particular, a coverage of the space of 2 π steradians around the appliance (the airplane being vulnerable on the ground and in flight), no alteration to the aerodynamic drag, low weight and footprint, a guarantee of safety for people, low cost.

The equipment used today to provide the self-protection functions against the firing of missiles include, in a known way, an infrared camera which, once a missile is detected, for example by an ultraviolet detector and/or a radar, identifies the missile from its combustion flame and/or its radar signature. Tracking is provided by the emitting of a laser beam, the orientation of which is handled by a line-of-sight orientation device, associated with a laser detector of the four-dial detector type, which detects the laser stream reflected by the optics of the homing head of the missile, through the “cat's eye” effect. The so-called jamming laser then sends a signal appropriate to the mode of operation of the homing head of the missile (frequency modulation or amplitude modulation) to the optics of the latter in order to mislead it.

However, the architecture of such equipment adapted to military carriers is costly and heavy, and the aerodynamic drag generated is totally incompatible with civilian requirements, except by making them retractable, which would then be more detrimental to the weight budgets and therefore to the payload for these same airplanes.

The present invention can be used to overcome the abovementioned drawbacks by proposing an anti-missile protection system with an optoelectronic module of reduced footprint, capable of being adapted to the constraints of civilian airplanes.

More specifically, the invention proposes an anti-missile protection system for an aircraft, characterized in that it comprises at least one optoelectronic module, each module being equipped with a device for detecting and tracking missiles in a given space, with, in particular, a missile jamming laser beam emitting head and, for each optoelectronic module, a service box for controlling and supplying power to the module, each box being remote from the optoelectronic module that it controls and also comprising the electronics for controlling the jamming laser of said module.

According to the invention, it is possible thanks to the particular architecture of the protection system, to position on one and the same carrier, a number of optoelectronic modules, to provide a complete coverage of the surveillance space.

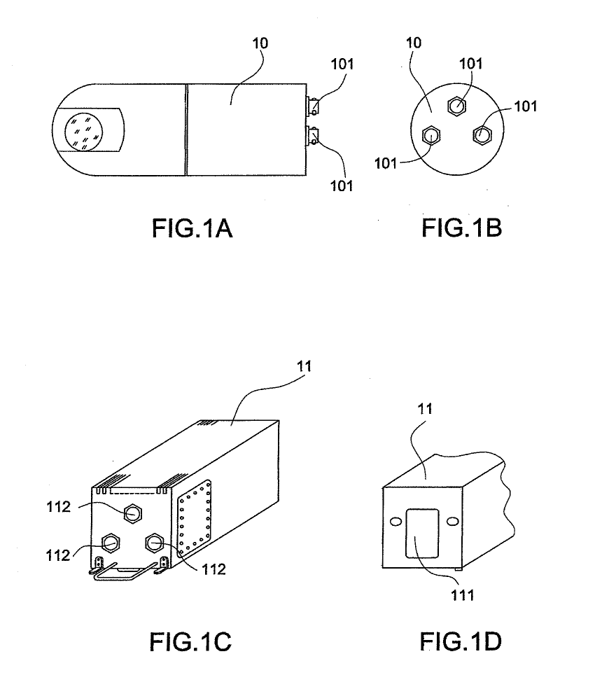

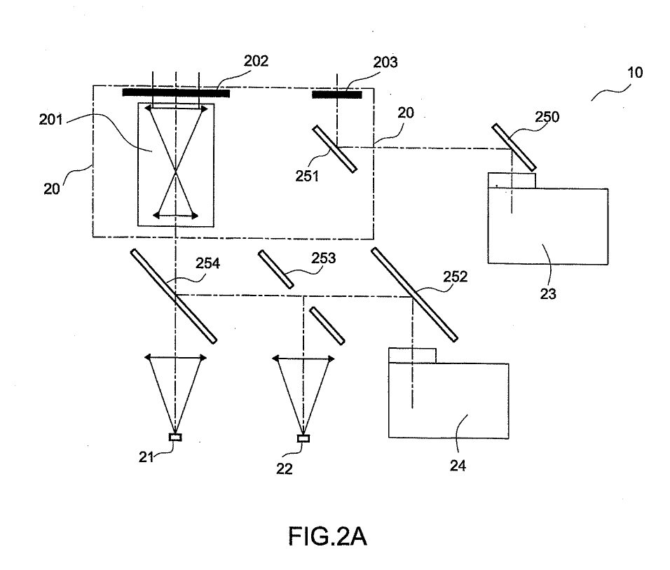

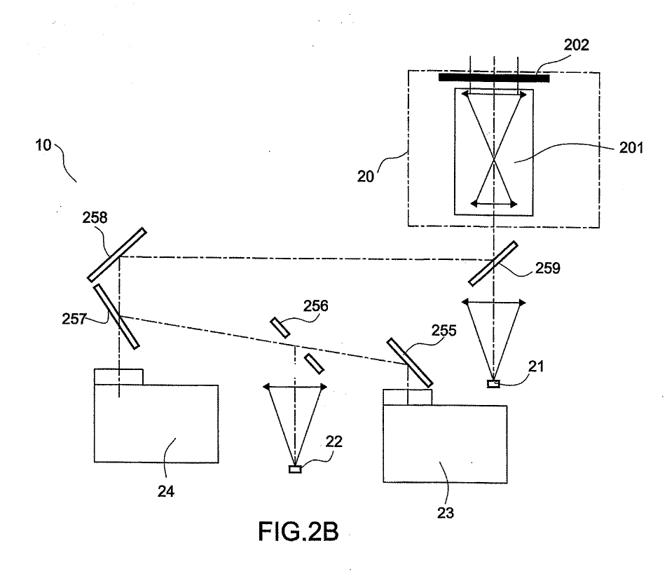

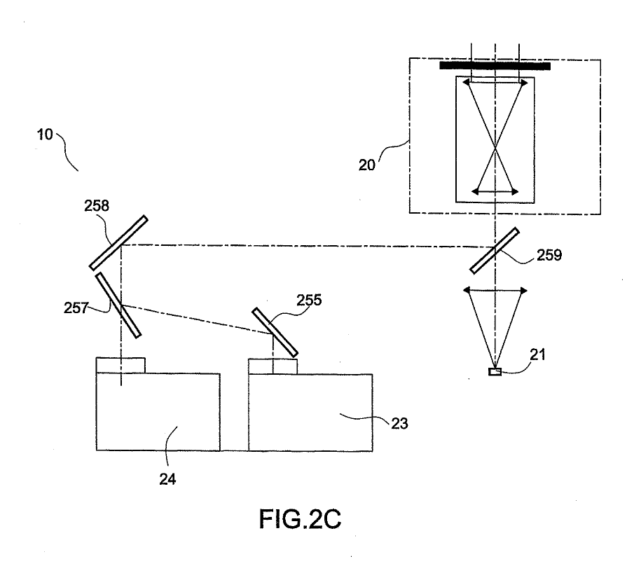

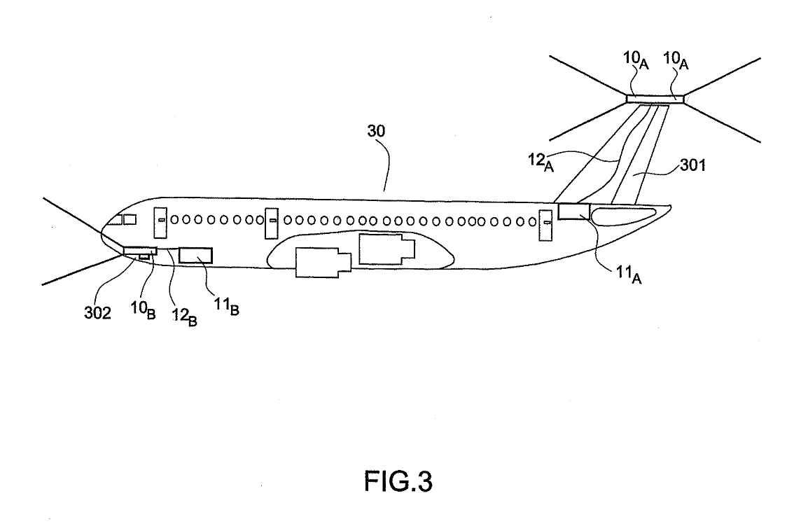

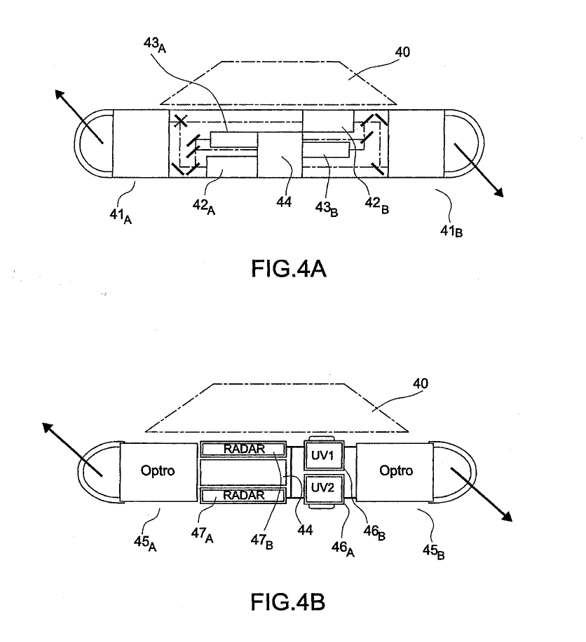

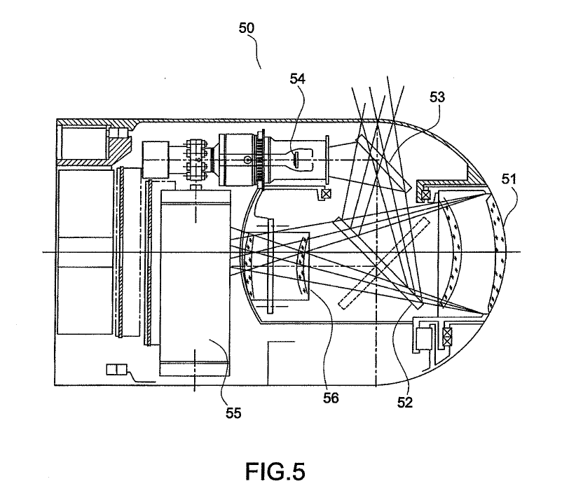

Other advantages and characteristics will become more clearly apparent from reading the description that follows, illustrated by the appended figures which represent:
FIGS. 1A to 1D, views showing the external enclosures respectively of an optoelectronic module and of its service box of a protection system according to an exemplary embodiment;
FIGS. 2A to 2C, exemplary architectures for optoelectronic modules of the system according to the invention;
FIG. 3, an exemplary layout of a surveillance system according to the invention for a civilian carrier type aircraft;
FIGS. 4A and 4B, two optoelectronic modules of a protection system according to the invention, mounted nose-to-tail;
FIG. 5, an exemplary embodiment of an optoelectronic module of the system according to the invention (partial view), according to a variant.

In the figures, identical elements are indexed by the same references.

FIGS. 1A to 1D represent views of the external enclosures respectively of an optoelectronic module 10 (FIGS. 1A, 1B) and of its service box 11 (FIGS. 1C, 1D) in an anti-missile protection system according to the invention, in an exemplary embodiment. The anti-missile protection system according to the invention provides for at least one optoelectronic module located on the aircraft, each module being equipped with a device for detecting and tracking the missiles in a given surveillance space, with, in particular, a jamming laser beam emitting head, and, for each optoelectronic module, a service box for controlling the module and supplying electricity thereto. The jamming laser participates initially in identifying and tracking the missile by sight of its homing head, then is used for the jamming proper, by sending sufficient energy pulses to mislead the homing head of the missile. According to the invention, each box 11 is remote from the optoelectronic module 10 that it controls, electrically linked to the module by a cable or any other means of transmitting electrical energy. The service box includes the electrical power supplies for the optoelectronics components of the optoelectronic module, the electronics for processing signals delivered by the detectors of the optoelectronic module, the computer, the interfaces with the carrier. According to the invention, it also comprises the electronics for controlling the jamming laser of the module 10, including in particular the laser processing and service power supply and electronics. This particular architecture, wherein the service box is remote from the optoelectronic module, that is, wherein the two elements are mechanically separate and can therefore be fixed independently of each other on the aircraft, the electronic control of the laser being incorporated in the service box, makes it possible to considerably reduce the weight and the footprint of the optoelectronic module. On a helicopter type aircraft, a surveillance system with just one optoelectronic module can be provided, said module being positioned under the helicopter. In the case of civilian or military airplane type carriers, the surveillance system according to the invention makes it possible to set up several optoelectronic modules, for example two or three, to obtain a complete coverage of the surveillance space.

According to a variant, the laser cavity, the pumping module and the jamming laser amplifier are also remote from the optoelectronic module 10, in a separate laser box or in the service box itself. Only the laser emitting head, formed, for example, by an optical parametric oscillator type frequency conversion module, is maintained in the optoelectronic module, making it possible to further reduce the weight and footprint. In this case, the beam from the laser amplifier is transported to the laser emitting head of the optoelectronic module by an optical fiber type optical transport means. This configuration allows for an optoelectronic module limited to its minimum footprint, which can be positioned on the aircraft, in places hitherto inaccessible but nevertheless strategic from the point of view of the anti-missile protection of the airplane such as, for example, at the top of the stabilizer of the airplane. In this case, the service box and the laser box will, for example, be remotely situated at the bottom of the stabilizer.

The anti-missile protection system according to the invention, because of the saving in footprint that it provides, also makes it possible to set up a refined protection system wherein, in addition to the jamming laser, a destruction laser is provided, only the emitting head of said laser being located in the optoelectronic module. This functionality is very important to the safety of people. In practice, if the missile tracking system continues to detect the presence of the latter despite the firing of jamming laser pulses, the destruction laser can then be directed to the homing head of the missile, in order to destroy the homing head.

FIGS. 1A and 1B thus respectively represent the profile and rear views of the external enclosure of an optoelectronic module 10, equipped with connectors for connecting to the service box. The enclosure of an exemplary service box is represented in FIGS. 1C and 1D. In FIG. 1D (rear view) the connector 111 that will receive the connections from the connectors 101 of the optoelectronic module, is diagrammatically represented. In FIG. 1C, front side, the connectors 112 are intended for connection to the carrier.

According to a variant, the protection system can include a single service box of the type of that represented in FIGS. 1C and 1D for controlling all the optoelectronic modules and supplying power thereto. In this case, the box comprises, for example, a shared laser power supply making it possible to supply the jamming laser of one or other of the modules, alternately, and a laser power supply for supplying power to the destruction laser of one or other of the modules, if such a laser is provided.

FIGS. 2A to 2C diagrammatically describe two exemplary architectures for the optoelectronic modules 10 of the system according to the invention.

The optoelectronic module comprises in the example of FIG. 2A, a detection and tracking device with an infrared imaging detector 21, a laser detector 22 for tracking the missile, of four-dial detector type, a jamming laser emitting head 23, a destruction laser emitting head 24 and a line-of-sight orientation device 20 common to the detectors and to the jamming and destruction laser emitting heads. In this example, the device 20 comprises an afocal lens 201 for tracking missiles, associated with a first window 202 suited to the spectral bandwidth of the infrared detector 21, said lens and said window being mounted on a mechanical structure that is mobile elevation-wise and bearing-wise. A set of mirrors (250 to 254), including, for example, three fixed mirrors (251, 252, 254) and two fine stabilization mirrors (250, 253) provide the returns to the detectors and orientation of the laser beams towards the orientation device. In this example, the line-of-sight orientation device comprises a second window 203, mounted on the support structure of the tracking lens, and suited to the wavelength of the jamming laser 23. The service box comprising in particular the laser power supplies is not shown in this figure.

According to a variant represented in FIG. 2B, the mechanical structure comprises only one window (202) with an appropriate spectral bandwidth, the set of the mirrors (255 to 259) being arranged so that the jamming laser beam leaves the optoelectronic module via this single window.

According to a variant represented in FIG. 2C, the infrared imaging detector is also the laser detector for tracking the missile, so there is no specific four-dial type detector as in the example of FIG. 2A or 2B, which makes it possible to further reduce the footprint of the module and the cost of the system.

FIG. 3 represents an exemplary layout of a surveillance system according to the invention on a civilian carrier type aircraft 30. In this example, the protection system comprises three optoelectronic modules, which makes it possible to provide a maximum coverage of the surveillance space. Two optoelectronic modules 10_{A} are positioned nose-to-tail at the top of the stabilizer 301 of the carrier, and are linked by a link 12_{A} to a service box 11_{A} common to the two modules. The link is electrical and optical in the case where the laser cavity and the laser amplifier would also be remote from the optoelectronic module. A third optoelectronic module 10_{B} is in this example provided beneath the nose 302 of the carrier, making it possible to cover the surveillance space underneath the airplane.

Although two optoelectronic modules are already interesting for providing a good coverage of the surveillance space, it is advantageous to arrange three on the aircraft, so as to provide a protection in a space of 2 π steradians.

According to a variant (such as that illustrated for example in FIG. 3), it may be interesting to position two optoelectronic modules nose-to-tail for the surveillance of two complementary half-spaces. In this case, the jamming laser beam emitting head can be common to the two optoelectronic modules, and the destruction laser beam emitting head if the latter is provided. There will then, for example, be two modules nose-to-tail at the top of the stabilizer and a third module beneath the nose of the aircraft, or two modules nose-to-tail in the form of a pod borne externally and a third module on the top of the fuselage. Other configurations are, of course, possible for the protection system according to the invention, such as, for example, to provide for three separate modules, two each side of the airplane to the rear of the fuselage and one on top of the fuselage, the main thing being that a maximum protection space is covered, while respecting the weight and aerodynamic drag increase limits that are acceptable in each case.

FIG. 4A represents the arrangement of two optoelectronic modules nose-to-tail in a surveillance system according to the invention. According to this example, the two optoelectronic modules are intended to be mounted in the form of a pod borne externally to the airplane, for example by means of a mast 40. Each optoelectronic module comprises a nose 41_{A}, 41_{B} with the line-of-sight orientation device, the infrared detectors (respectively 42_{A} and 42_{B}) and laser tracking detectors (respectively 43_{A} and 43_{B}), and a jamming laser beam emitting head 44 which, in this example, is common to the two optoelectronic modules. The service box of the optoelectronic modules is, for example, remote in the fuselage of the aircraft. A destruction laser beam emitting head can also be provided (not shown).

FIG. 4B shows a variant according to which each optoelectronic module also comprises an ultraviolet detection device (46_{A} and 46_{B}) and/or a missile radar detection device (47_{A} and 47_{B}), said devices being positioned in an additional block between the two optoelectronic modules.

FIG. 5 illustrates a particular exemplary embodiment of an optoelectronic module 50 that is particularly interesting for its compactness. Only the laser emitting head is not shown. The optoelectronic module comprises in particular a line-of-sight orientation device with a mechanical structure that is mobile elevation-wise and bearing-wise, supporting an afocal tracking lens 51 (which, in this example, also serves as a window). The line-of-sight orientation device also comprises a set of return mirrors, including at least one return mirror 52 towards the infrared detector 54. A compressor 55 cools the infrared detector 54. According to this example, the infrared detector 54 handles the laser tracking function, so an additional specific detector is no longer needed.

According to this variant, an additional functionality is provided for the optoelectronic module 50. This is an FLIR (Forward Looking Infra-Red) function making it possible to offer the system and, in particular, the module located beneath the nose of the aircraft, a navigation and landing aid function for the crew. For this, a specific lens 56 is provided, included on the same structure as the lens of the tracking system, and made active by 180° rotation of the mechanical structure and by 90° switching of the mirror 52. Given the detector employed, this lens makes it possible to provide an optical field compatible with these functions. It should be noted that this field is addressable elevation-wise and bearing-wise via the line-of-sight orientation device, which is particularly interesting in landing phases with a strong angle of attack and side-slip of the aircraft.

1. An anti-missile protection system for an aircraft, characterized in that it comprises at least one optoelectronic module, each module being equipped with a device for detecting and tracking missiles in a given space, with, in particular, a missile jamming laser beam emitting head, and, for each optoelectronic module, a service box for controlling and supplying power to the module, each box being remote from the optoelectronic module that it controls and also comprising the electronics for controlling the jamming laser of said module, and in which, each laser comprising in addition to the laser beam emitting head, a laser cavity and a laser amplifier, said laser cavity and amplifier being remote from the optoelectronic module comprising the laser emitting head.

2. The protection system as claimed in claim 1, wherein each optoelectronic module also comprises a missile destruction laser beam emitting head, each service box also comprising the electronics for controlling the destruction laser of the module that it controls.

3. The protection system as claimed in claim 1, wherein said laser cavity and amplifier are positioned in the service box for the control of said module.

4. The protection system as claimed in claim 1, wherein the emitting head comprises a frequency conversion module.

5. The protection system as claimed in claim 1, wherein the missile detection and tracking device of each optoelectronic module comprises an infrared imaging detector, a laser detector for tracking the missile and a line-of-sight orientation device common to said detectors and to the jamming laser emitting head.

6. The protection system as claimed in claim 5, wherein, each optoelectronic module also comprising a missile destruction laser beam emitting head, said line-of-sight orientation device is common to said detectors, to the emitting head of the jamming laser and to that of the destruction laser.

7. The protection system as claimed in claim 5, wherein the infrared imaging detector (54) is also the laser detector for tracking the missile.

8. The protection system as claimed in claim 5, wherein the line-of-sight orientation device comprises in particular a tracking lens, mobile elevation-wise and bearing-wise, and a set of return mirrors, including at least one return mirror towards the infrared detector.

9. The protection system as claimed in claim 8, wherein the line-of-sight orientation device comprises a specific lens, mounted on the same support structure as the tracking lens, and being made active by the 180° rotation of said structure and 90° switching of the return mirror towards the infrared detector, to offer the system a specific navigation and landing aid function.

10. The protection system as claimed in claim 1, comprising at least two optoelectronic modules and a single service box for the control and power supply of at least two of said optoelectronic modules.

11. The protection system as claimed in claim 1, comprising three optoelectronic modules positioned so as to ensure a protection in a space of 2 π steradians.

12. The protection system as claimed in claim 1, comprising at least two optoelectronic modules, two of said optoelectronic modules being positioned nose-to-tail for the surveillance of two complementary half-spaces.

13. The protection system as claimed in claim 12, wherein the jamming laser beam emitting head is common to both of said optoelectronic modules.

14. The protection system as claimed in claim 12, wherein, each optoelectronic module also comprising a missile destruction laser beam emitting head, the destruction laser beam emitting head is common to both said optoelectronic modules.

15. The protection system as claimed in claim 12, wherein, each optoelectronic module also comprising an ultraviolet detection device and/or a radar detection device for the missiles, said devices are positioned in an additional block between the two of said optoelectronic modules.

16. An airplane equipped with an anti-missile protection system as claimed in claim 12, the two of said modules being mounted in the form of a pod supported outside the airplane.

17. The airplane as claimed in claim 16, wherein said anti-missile protection system comprises a third optoelectronic module positioned on the top of the fuselage of the airplane.

18. The airplane equipped with an anti-missile protection system as claimed in claim 12, the two of said modules being mounted at the top of the stabilizer of the airplane.

19. The airplane as claimed in claim 18, wherein said anti-missile protection system comprises a third optoelectronic module positioned under the nose of the airplane.
